(19) United States
(12) Patent Application Publication
(10) Pub. No.: US 2009/0027905 A1
(43) Pub. Date: Jan. 29, 2009

(54) SUNVISOR LIGHTING APPARATUS FOR VEHICLE

(76) Inventor: Jae Eun Chang, Gwangmyeong-si (KR)

Correspondence Address: MORGAN, LEWIS & BOCKIUS LLP (SF), One Market, Spear Street Tower, Suite 2800, San Francisco, CA, 94105, US

(21) Appl. No.: 11/942,595

(22) Filed: Nov. 19, 2007

(30) Foreign Application Priority Data
Jul. 27, 2007 (KR) 10-2007-0075958

(51) Int. Cl. B60Q 1/00

(52) U.S. Cl. 362/492

(57) ABSTRACT

A sunvisor lighting apparatus for use with a vehicle sunvisor that is pivotably mounted to a head liner, and is user-manipulable between an open and a closed position. The apparatus includes a lighting section, installed in the head liner at a position where the sunvisor covers the head liner when the sunvisor is closed. The lighting section is user-tiltable between an off position at which a light source is turned off, and at least one on position at which the light source is turned on.

### CROSS-REFERENCE TO RELATED APPLICATIONS

This application claims priority to Korean Application No. 10-2007-0075958, filed on Jul. 27, 2007, the disclosure of which is incorporated herein by reference.

### BACKGROUND OF THE INVENTION

(1) Field of the Invention

The present invention relates to a sunvisor lighting apparatus for a vehicle which is capable of angle adjustment, and which is turned off when the sunvisor is closed.

(2) Description of the Prior Art

A sunvisor lighting apparatus is typically provided to allow a user to use the mirror of the sunvisor at night or in the dark. After the user unfolds the sunvisor from the head liner, he or she opens a mirror cover, exposing the mirror. A light is fixedly installed in the head liner, and is turned on and off by opening and closing the mirror cover.

However, since the light is turned on whenever the mirror cover is opened, regardless of ambient lighting conditions, power is consumed unnecessarily, and the lifetime of the light is shortened. Moreover, since the light is immovable within the head liner, the user must move his or her body toward the lighting section 10, which is inconvenient, and may include unfastening his or her seat belt.

The information disclosed in this Background of the Invention section is only for enhancement of understanding of the background of the invention and should not be taken as an acknowledgement or any form of suggestion that this information forms the prior art that is already known to a person skilled in the art.

### SUMMARY OF THE INVENTION

A sunvisor lighting apparatus for use with a vehicle sunvisor that is pivotably mounted to a head liner, and is user-manipulable between an open and a closed position. The apparatus includes a lighting section, installed in the head liner at a position where the sunvisor covers the head liner when the sunvisor is closed. The lighting section is user-tiltable between an off position at which a light source is turned off, and at least one on position at which the light source is turned on.

The off position may be defined by an outer surface of the lighting section being parallel to a surface of the head liner. The on position may be defined by the outer surface of the lighting section being inclined with respect to the surface of the head liner.

The lighting section may also include a lens part, and an adjustment mechanism behind the lens part. The adjustment mechanism may be mounted in a housing in the head liner, and may be tiltable within the housing.

### BRIEF DESCRIPTION OF THE DRAWINGS

The above and other features of the present invention will now be described in detail with reference to certain exemplary embodiments thereof illustrated the accompanying drawing, which is given by way of illustration only, and is not limitative of the present invention, and wherein:

FIG. 1 is a cross-sectional view illustrating a sunvisor lighting apparatus for a vehicle in accordance with an embodiment of the present invention.

It should be understood that the appended drawing is not necessarily to scale, presenting a somewhat simplified representation of various preferred features illustrative of the basic principles of the invention. The specific design features of the present invention as disclosed herein, including, for example, specific dimensions, orientations, locations, and shapes, will be determined in part by the particular intended application and use environment.

### DETAILED DESCRIPTION OF PREFERRED EMBODIMENTS

Hereinafter reference will now be made in detail to a preferred embodiment of the present invention, an example of which is illustrated in the accompanying drawing and described below. While the invention will be described in conjunction with an exemplary embodiment, it will be understood that present description is not intended to limit the invention to the exemplary embodiment. On the contrary, the invention is intended to cover not only the exemplary embodiment, but also various alternatives, modifications, equivalents and other embodiments, which may be included within the spirit and scope of the invention as defined by the appended claims.

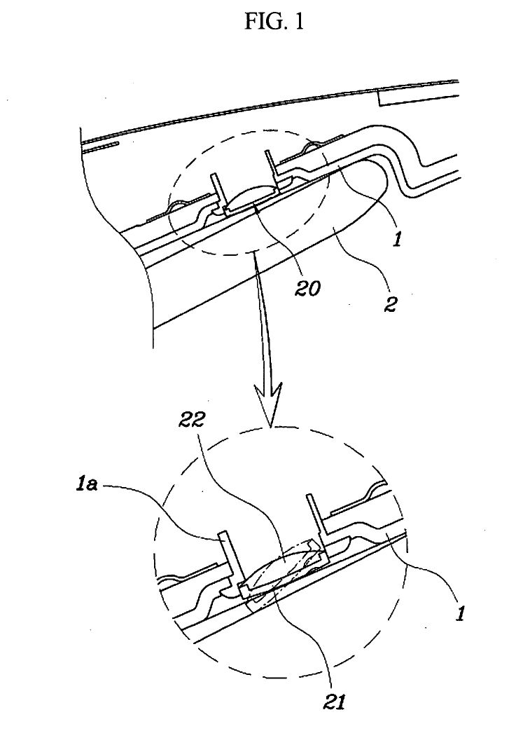

Referring to FIG. 1, a head liner 1 is provided on a roof panel in the cabin of a vehicle. A sunvisor 2 is pivotably installed on the head liner 1 and is capable of being folded to and unfolded from the head liner 1. The sunvisor 2 may include a mirror and a mirror cover, omitted in the Figure for simplicity.

A lighting section 20 is installed in the head liner 1 at a position that is covered by the sunvisor 2 when the sunvisor 2 is in the closed position. The angle of the lighting section 20 is user-adjustable.

For example, the lighting section 20 is composed of a lens part 21 that emits light, and an adjustment mechanism 22, attached to the back of the lens part 21.

The adjustment mechanism 22 may be curved, as illustrated, and is fitted into a housing 1a in the head liner 1. The adjustment mechanism 22 is thus in sliding contact with the housing 1a, to thereby enable the angle adjustment.

When the angle of the lighting section 20 is adjusted by the user, the lighting section 20 is turned on. In its rest position, when the outer surface of the lighting section 20 is parallel to the head liner 1, the lighting section 20 remains turned off.

The configuration in which the lighting section 20 is turned on when the angle is adjusted can be designed and implemented by a person of ordinary skill in the art based on the teachings herein.

With the sunvisor 2 unfolded from the head liner 1, even when the mirror cover is opened, if the angle of the lighting section 20 is not adjusted, the lighting section 20 is not turned on. Thus, it is possible to prevent electric power from being wasted when it is not necessary to turn on the lighting section 20. In the dark, the lighting section 20 is turned on when the user manually adjusts the angle of the lighting section 20.

To turn off the lighting section 20, it can be directly returned to its off position by hand. Alternatively, by folding the sunvisor 2 to the head liner 1, the lighting section 20 is returned to its off position by being pressed by the sunvisor, and is turned off.

As is apparent from the above description, a user can use the light in a comfortable posture without the need to move his or her body. Further, unnecessary power consumption is prevented.

Although a preferred embodiment of the present invention has been described for illustrative purposes, those skilled in the art will appreciate that various modifications, additions and substitutions are possible, without departing from the scope and spirit of the invention as defined in the accompanying claims.

1-2. (canceled)

3. The sunvisor lighting apparatus according to claim 5, wherein the lighting section further comprises a lens part, and an adjustment mechanism behind the lens part.

4. The sunvisor lighting apparatus according to claim 3, wherein the adjustment mechanism is disposed in a housing in the head liner, and is tiltable within the housing.

5. A sunvisor lighting apparatus for a vehicle, the vehicle comprising a sunvisor which is pivotably mounted to a head liner and is user-manipulable between an open and a closed position, the apparatus comprising:
a lighting section comprising a light source and installed in the head liner at a position where the sunvisor covers the head liner when the sunvisor is closed, the lighting section being user-tiltable between an off position at which the light source is off and an outer surface of the lighting section is substantially parallel to a surface of head liner, and at least one on position at which the light source is on and the outer surface of the lighting section is inclined with respect to the surface of the head liner,
wherein the light source is turned on when the outer surface of the lighting section is inclined with respect to the surface of the head liner.
